(19) United States
(12) Patent Application Publication
(10) Pub. No.: US 2004/0117521 A1
(43) Pub. Date: Jun. 17, 2004

(54) Sounding apparatus and personal computer system having sounding apparatus

(75) Inventors: Chun-Hung Chen, Taipei (TW); Brandon Liu, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Via Technologies, Inc., Shindian City (TW)

(21) Appl. No.: 10/676,748

(22) Filed: Oct. 1, 2003

(30) Foreign Application Priority Data
Oct. 2, 2002 (TW) 091122776

(51) Int. Cl. G06F 13/38

(52) U.S. Cl. 710/62

(57) ABSTRACT

A sounding apparatus for use with a personal computer includes an external data bus control circuit, an analog circuit and a speaker. The external data bus control circuit receives an audio signal from a core logic unit of the personal computer. The analog circuit is electrically connected to the external data bus control circuit for converting the audio signal into an analog signal and amplifying power of the analog signal. The speaker is electrically connected to the analog circuit for sounding in response to the amplified analog signal. Specifically, the external data bus control circuit, and the analog circuit are accommodated in the same housing as the speaker.

### FIELD OF THE INVENTION

The present invention relates to a sounding apparatus and a personal computer system having a sounding apparatus.

### BACKGROUND OF THE INVENTION

In a conventional personal computer system as shown in FIG. 1, a north bridge chip 11 and a south bridge chip 12 are used to control data flows among a microprocessor 10, a system memory 13, and a plurality of I/O devices including a sound card 14. The sound card 14 is originally plugged in an expansion slot of a main board (not shown) for processing sound effects. The circuits of the sound card 14 are usually divided into two portions, i.e. a digital audio circuit 141 and an analog circuit 142. The digital audio circuit 141 is employed to process digital signals. Whereas, the analog circuit 142 performs a digital-analog converting operation and a power-amplifying operation, etc. By means of the digital-analog converting operation, the processed digital signals are converted into analog signals. Subsequently, the analog circuit 142 performing the power-amplifying operation amplifies these analog signals to drive a speaker 15 to sound.

With the rapid improvement of semiconductor chips and the increasing high integration level of circuits, the companies specialized in designing chipsets integrate the digital audio circuit 141 into the south bridge chip 12. In other words, a single chip having essentially functions of the analog circuit 142 is mounted on the main board, as can be seen in FIG. 2, instead of the conventional sound card. In such way, the cost for fabricating the main board is effectively reduced without increasing cost of chipsets. A common architecture of the integrated chip is, for example, an Audio Codec 97 (AC97 for short), which is commercially available from Intel Corporation, USA. The digital audio circuit 141 of the Audio Codec 97 is implemented by a digital audio controller and integrated into the south bridge chip 12. On the other hand, the analog circuit 142 comprises a digital-to-analog decoder (also referred as a codec) and a power amplifier.

However, as the main board is developed toward miniature, the components on the main board are jam-mounted. Since the single chip and the associated components such as signal lines and connectors still occupy considerable space on the main board, the miniature of the main board is restricted.

### SUMMARY OF THE INVENTION

It is an object of the present invention to provide a personal computer system having the sounding-related components removed from the main board so as to facilitate the miniature of the main board.

It is another object of the present invention to provide a sounding apparatus for use with a computer host, where the sounding-related components originally disposed in the main board are built-in.

In accordance with a first aspect of the present invention, there is provided a sounding apparatus for use with a personal computer. The personal computer comprises a core logic unit including a south bridge chip. The sounding apparatus comprises an external data bus control circuit, an analog circuit and a speaker. The external data bus control circuit receives an audio signal from the core logic unit. The analog circuit is electrically connected to the external data bus control circuit for converting the audio signal into an analog signal and amplifying power of the analog signal. The speaker is electrically connected to the analog circuit for sounding in response to the amplified analog signal. Especially, the external data bus control circuit, the analog circuit and the speaker are accommodated in the same housing.

In an embodiment, the audio signal is outputted from a digital audio circuit integrated into the south bridge chip.

In an embodiment, the audio signal is transmitted from the core logic unit to the external data bus control circuit via an external data bus socket electrically connected to the core logic unit and an external data bus connector electrically connected to the sounding apparatus.

In an embodiment, the external data bus connector and the external data bus control circuit are a universal serial bus (USB) connector and a universal serial bus (USB) control circuit, respectively. Alternatively, the external data bus connector and the external data bus control circuit are an IEEE 1394 signal bus connector and an IEEE 1394 signal bus control circuit, respectively.

In an embodiment, the external data bus connector is hot plug-unplug and has a function of universal plug and play (UPnP).

In an embodiment, the analog circuit comprises a codec for converting the audio signal into the analog signal, and a power amplifier for amplifying power of the analog signal.

In an embodiment, the codec complies with architecture of Audio Codec 97.

In accordance with a second aspect of the present invention, there is provided a sounding apparatus for use in a personal computer system. The personal computer system comprises an external data bus socket for receiving an external data bus. The sounding apparatus comprises an external data bus connector, an external data bus control circuit, a codec, a power amplifier and a speaker. The external data bus connector is plugged in the external data bus socket. The external data bus control circuit is electrically connected to the external data bus connector, and processes an audio signal received from the personal computer system via the external data bus. The codec is electrically connected to the external data bus control circuit for converting the audio signal into an analog signal. The power amplifier is used for amplifying power of the analog signal. The speaker is electrically connected to the power amplifier for sounding in response to the amplified analog signal.

In an embodiment, the external data bus control circuit, the codec, the power amplifier and the speaker are enclosed with the same housing.

In accordance with a third aspect of the present invention, there is provided a personal computer system. The personal computer system comprises a core logic unit, an external data bus and a sounding apparatus. The core logic unit integrates therein a digital audio circuit. The external data bus is in communication with the digital audio circuit of the core logic unit for transmitting an audio signal outputted from the digital audio circuit. The sounding apparatus includes an external data bus control circuit in communication with the external data bus, a codec, a power amplifier and a speaker. The codec, the external data bus control circuit, the power amplifier and the speaker are accommodated in the same housing.

In an embodiment, the core logic unit is a south bridge chip integrating therein the digital audio circuit.

In an embodiment, the codec and the digital audio circuit comply with the architecture of Audio Codec 97.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a block diagram showing the configuration of a conventional personal computer system;

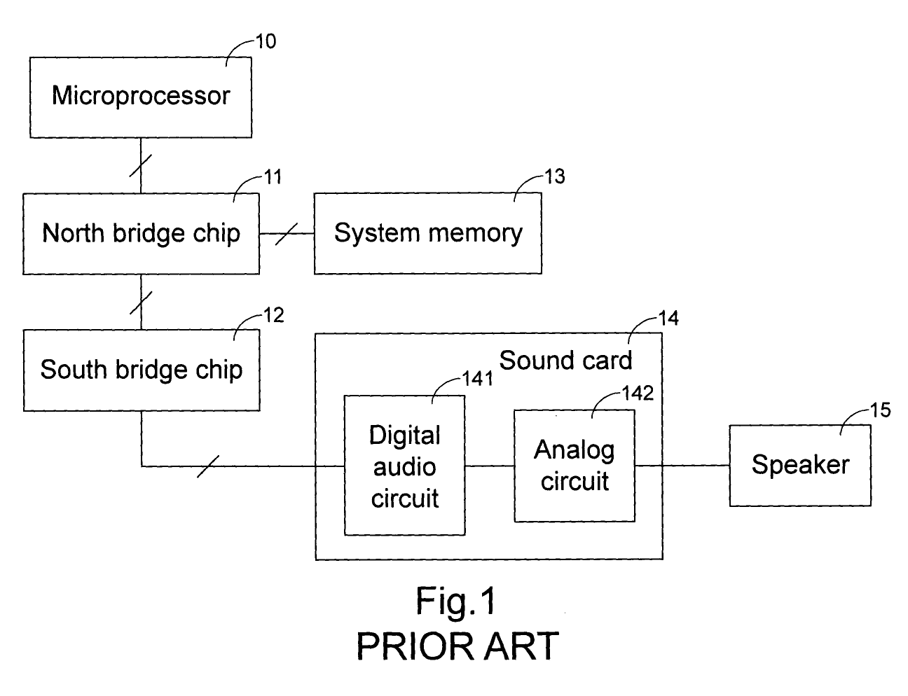

FIG. 2 is a block diagram showing the configuration of another conventional personal computer system; and

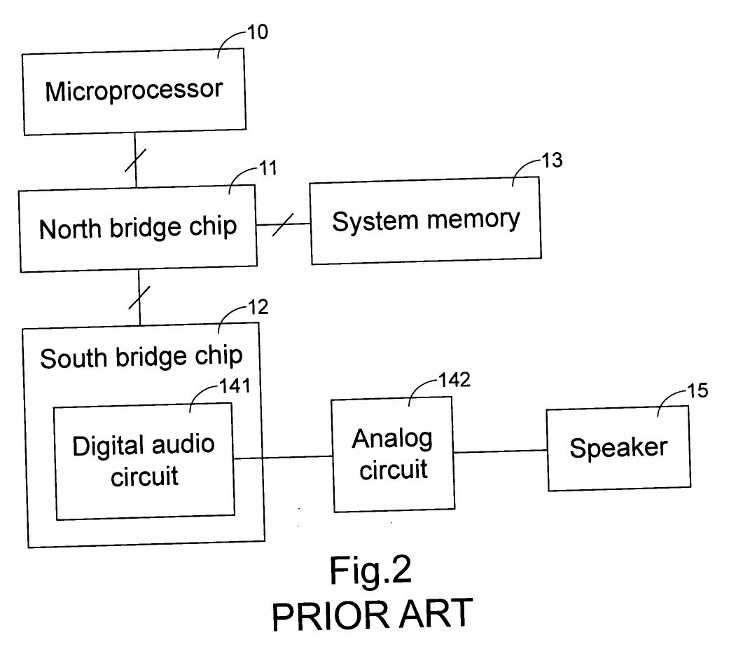

FIG. 3 is a block diagram showing the configuration of a personal computer system according to an embodiment of the present invention.

### DETAILED DESCRIPTION OF THE PREFERRED EMBODIMENT

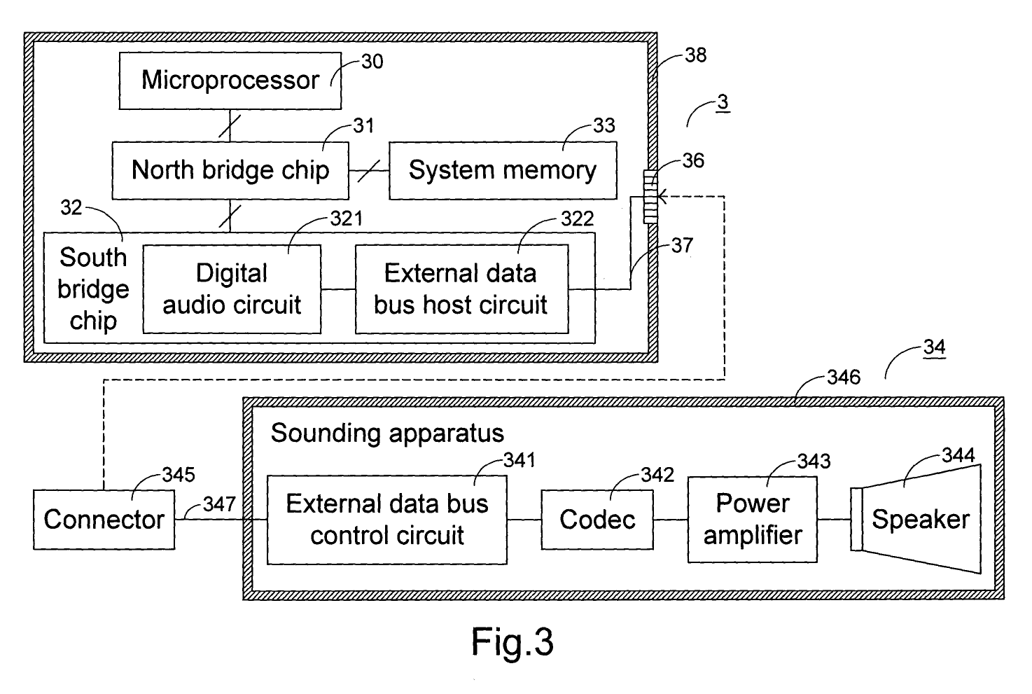

Referring to FIG. 3, a personal computer system including a computer host and a sounding apparatus according to an embodiment of the present invention is shown. The computer host 3 comprises a microprocessor 30, a north bridge chip 31, a south bridge chip 32, and a system memory 33. An external sounding apparatus 34 can be used with the computer host 3 to sound the information outputted by the computer host 3. The microprocessor 30, the north bridge chip 31, the south bridge chip 32 and the system memory 33 are enclosed with the housing 38 of the computer host 3. On the housing 38 of the computer host 3, an external data bus socket 36 is disposed for connecting with an external data bus connector 345, which is securely wired to or detachably connected to the housing 346 of the sounding apparatus 34 via a cable 347, to conduct an external data bus 37.

The south bridge chip 32 integrates therein a digital audio circuit 321 and an external data bus host circuit 322. The digital audio circuit 321 can be, for example, a digital audio controller complying with the architecture of Audio Codec 97. The external data bus host circuit 322 can be selected from a universal series bus (USB) host circuit or an IEEE 1394 host circuit.

The sounding apparatus 34 comprises an external data bus control circuit 341, a codec 342, a power amplifier 343 and a speaker 344, which are accommodated in the housing 346 of the sounding apparatus 34. The external data bus control circuit 341 can be a universal serial bus (USB) control circuit or an IEEE 1394 signal bus control circuit. The codec 342 complies with the architecture of Audio Codec 97.

In operation, the external data bus connector 345 is first plugged in the external data bus socket 36 so as to electrically connect the sounding apparatus 34 to the computer host 3. When an audio signal is outputted from the digital audio circuit 321 integrated into the south bridge chip 32, the audio signal is transmitted to the external data bus control circuit 341 of the sounding apparatus 34 via the external data bus socket 36 and the external data bus connector 345. By means of the codec 342, the audio signal is converted into an analog signal. The power amplifier 343 then amplifies power of the analog signal. Afterwards, in response to the amplified analog signal, the speaker 344 sounds correspondingly.

Since the sounding-related components, for example the codec chip and the associated components such as signal lines and connectors, are removed from the main board under the architecture of the present invention, the miniature of the main board is promoted. Thus, the cost for fabricating the main board is effectively reduced.

When a universal series bus (USB) host circuit is selected, the external data bus connector 345 and the external data bus control circuit 341 are a universal serial bus (USB) connector and a universal serial bus (USB) control circuit, respectively. Whereas, when an IEEE 1394 host circuit is used, the external data bus connector 345 and the external data bus control circuit 341 are an IEEE 1394 signal bus connector and an IEEE 1394 signal bus control circuit, respectively. Moreover, the external data bus connector 345 is hot plug-unplug and has a function of universal plug and play (UPnP). Therefore, the sounding operation can be easily accomplished by plugging the external data bus connector electrically connected to the circuit of the sounding apparatus into the corresponding socket electrically connected to the circuit of the computer host.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A sounding apparatus for use with a personal computer, said personal computer comprising a core logic unit including a south bridge chip, said sounding apparatus comprising:
an external data bus control circuit receiving an audio signal from said core logic unit;
an analog circuit electrically connected to said external data bus control circuit for converting said audio signal into an analog signal and amplifying power of said analog signal; and
a speaker electrically connected to said analog circuit for sounding in response to said amplified analog signal,
wherein said external data bus control circuit, said analog circuit and said speaker are accommodated in the same housing.

2. The sounding apparatus according to claim 1 wherein said audio signal is outputted from a digital audio circuit integrated into said south bridge chip.

3. The sounding apparatus according to claim 1 wherein said audio signal is transmitted from said core logic unit to said external data bus control circuit via an external data bus socket electrically connected to said core logic unit and an external data bus connector electrically connected to said sounding apparatus.

4. The sounding apparatus according to claim 3 wherein said external data bus connector and said external data bus control circuit are a universal serial bus (USB) connector and a universal serial bus (USB) control circuit, respectively.

5. The sounding apparatus according to claim 3 wherein said external data bus connector and said external data bus control circuit are an IEEE 1394 signal bus connector and an IEEE 1394 signal bus control circuit, respectively.

6. The sounding apparatus according to claim 3 wherein said external data bus connector is hot plug-unplug and has a function of universal plug and play (UPnP).

7. The sounding apparatus according to claim 1 wherein said analog circuit comprises a codec for converting said audio signal into said analog signal, and a power amplifier for amplifying power of said analog signal.

8. The sounding apparatus according to claim 7 wherein said codec complies with architecture of Audio Codec 97.

9. A sounding apparatus for use in a personal computer system, said personal computer system comprising an external data bus socket for conducting an external data bus, said sounding apparatus comprising:
an external data bus connector plugged in said external data bus socket;
an external data bus control circuit electrically connected to said external data bus connector, and processing an audio signal received from said personal computer system via said external data bus;
a codec electrically connected to said external data bus control circuit for converting said audio signal into an analog signal;
a power amplifier for amplifying power of said analog signal; and
a speaker electrically connected to said power amplifier for sounding in response to said amplified analog signal.

10. The sounding apparatus according to claim 9 wherein said external data bus control circuit, said codec, said power amplifier and said speaker are enclosed with the same housing.

11. The sounding apparatus according to claim 9 wherein said external data bus connector is a universal series bus (USB) connector, and said external data bus control circuit is a USB control circuit.

12. The sounding apparatus according to claim 9 wherein said external data bus connector is an IEEE 1394 signal bus connector, and said external data bus control circuit is an IEEE 1394 signal bus control circuit.

13. The sounding apparatus according to claim 9 wherein said codec complies with architecture of Audio Codec 97.

14. A personal computer system comprising:
a core logic unit integrating therein a digital audio circuit;
an external data bus in communication with said digital audio circuit of said core logic unit for transmitting an audio signal outputted from said digital audio circuit; and
a sounding apparatus comprising an external data bus control circuit in communication with said external data bus, a codec in communication with said external data bus control circuit for converting said audio signal into an analog signal, a power amplifier for amplifying power of said analog signal, and a speaker electrically connected to said power amplifier for sounding in response to said amplified analog signal, said external data bus control circuit, said codec, said power amplifier and said speaker being accommodated in the same housing.

15. The personal computer system according to claim 14 wherein said core logic unit is a south bridge chip integrating therein said digital audio circuit.

16. The personal computer system according to claim 14 wherein said codec and said digital audio circuit comply with the architecture of Audio Codec 97.

17. The personal computer system according to claim 14 wherein said external data bus is a universal serial bus (USB), which is hot plug-unplug and has a function of universal plug and play (UPnP).

18. The personal computer system according to claim 14 wherein said external data bus is IEEE 1394 signal bus, which is hot plug-unplug and has a function of universal plug and play (UPnP).
